(19) United States
(12) Patent Application Publication
(10) Pub. No.: US 2005/0154733 A1
(43) Pub. Date: Jul. 14, 2005

(54) Real-time change detection for network systems

(76) Inventors: David Meltzer, Roswell, GA (US); Will Weisser, Atlanta, GA (US); Doug Gisby, Atlanta, GA (US); Jon Larimer, Roswell, GA (US); Jim Albert, Roswell, GA (US)

Correspondence Address: NEEDLE & ROSENBERG, P.C., SUITE 1000, 999 PEACHTREE STREET, ATLANTA, GA, 30309-3915, US

(21) Appl. No.: 11/004,289

(22) Filed: Dec. 3, 2004

Related U.S. Application Data
(60) Provisional application No. 60/527,542, filed on Dec. 5, 2003.
(60) Provisional application No. 60/535,890, filed on Jan. 12, 2004.

(51) Int. Cl. G06F 7/00

(52) U.S. Cl. 707/10

(57) ABSTRACT

A system for conducting continuous, real-time vulnerability detection of computer networks. The system includes a user interface, a scan engine and a database for obtaining and storing information concerning a network in general and devices and services that may interact with the network. The system provides continuous scanning of the network, each scan being compared with a predetermined baseline network configuration to determine if a change to the network has occurred. If a change has occurred, the system issues an alert informing a network administrator of the where and how the network has changed so appropriate action may be taken by the network administrator.

### CROSS-REFERENCE TO RELATED APPLICATION

This application claims priority to, and incorporates by reference, U.S. Application No. 60/527,542 entitled “CHANGE AND VULNERABILITY DETECTION OF NETWORK SYSTEMS” filed on Dec. 5, 2003, and U.S. Application No. 60/535,890 entitled “CHANGE AND VULNERABILITY DETECTION OF NETWORK SYSTEMS” filed on Jan. 12, 2004.

### BACKGROUND OF THE INVENTION

1. Field of the Invention

The present invention relates to security for a computer network. The present invention provides a method, system and computer program that affords continuous, real-time detection of network changes, vulnerabilities, and an inventory of the computer network.

2. Description of the Related Art

Currently, network security solutions include host and network-based solutions as well as vulnerability assessment and intrusion detection solutions. Most of the vulnerability assessment, intrusion detection solutions and network security solutions are audit based. Thus, any assessment of the network is periodic and subject to attack during the interim between assessments.

FIG. 1 is a cost timeline 50 illustrating costs associated with a given system in response to an attack on the network. The cost timeline 50 shows a cost 52 associated with a given type of solution 54 based on what time 56 the solution 54 reacts to a network attack. Since a large portion of network security solutions 54 are periodic or passive, a solution 54 against a network attack can only occur once the attack has commenced. In providing only a reactive solution 54 to a network attack, a great deal of time and money must be devoted to determining what damage has occurred to the network in order to institute a repair and cleanup effort. Consequently, additional monetary resources are tied up and cannot be devoted to other business ventures.

With such solutions implemented for protecting a network, it is extremely difficult for an information technology (IT) department to keep pace with changes occurring on a daily basis for a given network. Therefore, critical data is exposed and subject to theft from sophisticated intruders who use automated tools to gain entry into a vulnerable network. With the advent of self-propagating worms and viruses these vulnerabilities are subject to even greater exploitation by hackers, thereby costing companies a great deal of money and resources.

Accordingly, there is a need and desire for a more timely recognition of changes and vulnerabilities associated with a given network.

### SUMMARY OF THE INVENTION

The present invention provides for a continuous, real-time detection of changes, vulnerabilities and inventory for a given network. In an exemplary embodiment, a method and system are implemented to provide continuous monitoring of networks, to determine whether the network has acquired new systems or services, or whether current systems or services on the network have been altered. A user may instruct the system to monitor certain sub-systems and devices within a given network through a user interface. If the system determines that the network has been altered, the system issues an alert to the user of what type of change has occurred.

In a second exemplary embodiment, the system may be implemented using a single management server, a single graphical user interface (GUI) and a single scan engine.

### BRIEF DESCRIPTION OF THE DRAWINGS

The foregoing and other advantages and features of the invention will become more apparent from the detailed description of exemplary embodiments of the invention given below with reference to the accompanying drawings.

FIG. 1 is a timeline illustrating cost associated with a network security solution which is either proactive or reactive;

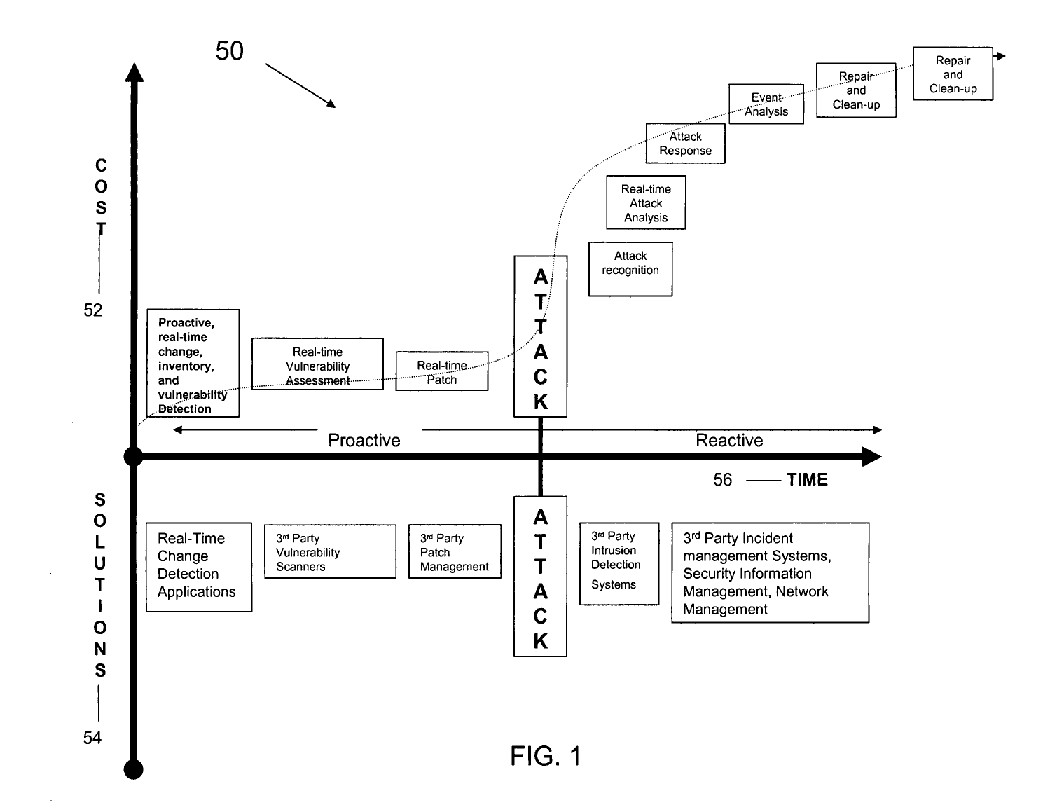

FIG. 2 is a block diagram illustrating a first embodiment of a vulnerability detection system for implementing the present invention;

FIG. 3 is a block diagram illustrating components internal to a management server of the present invention;

FIG. 4 is a block diagram illustrating components internal to a scan engine of the present invention;

FIG. 5 is a flow chart illustrating a continuous scanning loop implemented by the present invention;

FIG. 6 is a diagram illustrating a graphical user interface used to acquire bandwidth shaping settings from a user;

FIG. 7 is a screen illustrating a dialog box for use by a user to obtain a list of available parameters for a particular scanner used by the present invention;

FIG. 8 is a block diagram illustrating a second embodiment of a vulnerability detection system for implementing the present invention; and

FIG. 9 is a block diagram illustrating a computer network using the vulnerability detection systems of FIGS. 2 and 8.

### DETAILED DESCRIPTION OF THE INVENTION

In the following detailed description, reference is made to the accompanying drawings, which form a part hereof, and which is shown by way of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

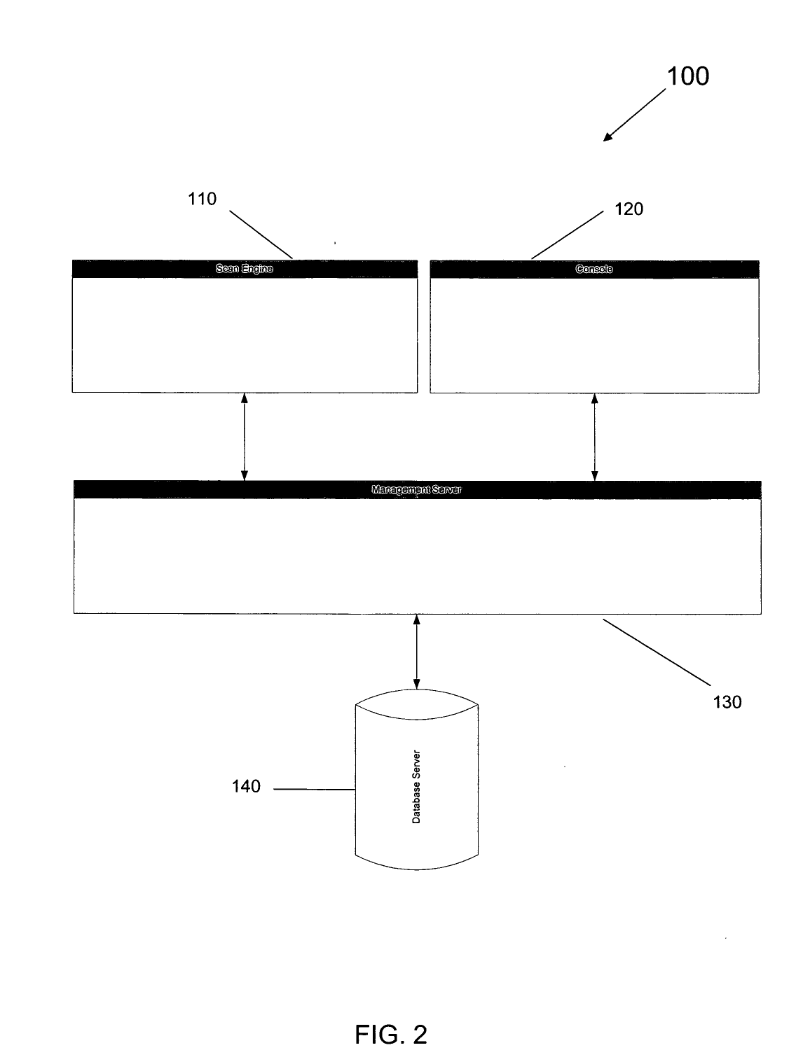

FIG. 2 is an exemplary processing system 100 with which the present invention may be used. System 100 includes a scan engine 110, a user console 120, a management server 130 and a database 140. User console 120 allows a user to configure the system 100 and designate which devices within a network should be monitored by the system 100. User console 120 also allows a user to enter what information the user desires to view in any reports output by system 100 regarding activity on the network. The scan engine 110 provides data collection from the network for comparison with a baseline network setting stored in database 140. Multiple scan engines 110 and multiple user consoles 120 may be used by system 100 during operation.

System 100 utilizes a scan engine 110 for monitoring the network. Upon a first interaction with a network, scan engine 110 actively probes devices, systems and services using standard network communication protocols, for example, transmission control protocol/Internet protocol (TCP/IP), to create a baseline for the current state of the network. The scan engine 110 then compares the baseline network information with information returned after any subsequent scan of the network. Scan engine 110 can detect changes at various layers of the network stack, for example, a web services layer.

The management server 130 manages the transfer of commands and information between scan engine 110, user console 120 and database 140. Management server 130 also relates information between clients and the network or between the clients themselves.

The user console 120 utilizes a port profile wizard which allows a user to specify which transmission control protocol (TCP) and user datagram protocol (UDP) ports should be monitored by the system 100. Using the port profile wizard, the user may specify an individual port or a range of sequential ports in a port profile, and may also specify whether a protocol for the port is TCP or UDP. The user may also assign a name to the port range and assign a criticality level to a particular port found on a particular device. Multiple port profiles may be created by the user for the network.

The user may additionally use the user console 120 to modify network profiles, such as an internet protocol (IP) address, an IP address range, subnet or domain name server (DNS) hostname, to be monitored by system 100. Each host in the network may be assigned a unique identifier as well as a criticality level associated with addition or removal of the host from the network.

Using the user console 120, a user may create a vulnerability profile using a vulnerability scanner profile wizard. Using the vulnerability scanner profile wizard, the user may specify which external vulnerability scanner will be launched (used) for a particular device when a change has been detected on the network. Once the user completes a vulnerability scanner profile, the system 100 creates a script for use by the management server 130. The management server 130 subsequently implements a vulnerability scan of the network using system 100. A vulnerability scanner profile may be assigned to each port profile to specify conditions which will trigger an external scan of the network by system 100.

The user console 120 also allows a user to employ application layer differential checks. Application layer differential checks are used to obtain specific information from a set of hosts or assets. For example, an application layer differential check may be used to obtain specific files on a file system, or to obtain a specific registry key. Application layer differential checks may be added to system 100 using, for example, a software application programming interface (API) or using a wizard. When using the wizard, the user may enter strings that should be sent to a new application or service upon connection. Subsequently, regular expressions may be parsed by the application or service to determine information about the application or service. The information returned from the application or service allows a heuristics engine to determine if a change has occurred between checks of the application or service. The application layer differential checks may be applied to one or more application or service ports and may be enabled on a per-network profile basis.

The user console 120 also allows the user to set network bandwidth shaping configurations for system 100. By setting a network bandwidth, the user sets the maximum bandwidth that may be used by system 100 in communications with other devices over the network. Thus, the bandwidth shaping configuration sets a maximum throughput for a given network profile. The bandwidth shaping configuration may also set a maximum throughput for an aggregate of all network profiles.

In addition, the user console 120 allows the user to review information regarding a device inventory for a network in real-time. Depending on the configuration of system 100 and the type of device connected to the network, the user may review information concerning services running on the device, software installed on the device, the configuration of the device and up-to-date vulnerabilities that exist for the device. The user may also view alerts that have been generated by the scan engine 110. An alert is a notification to the user that a change to the network has occurred; for example, a device is added to a web server on the network. Information included with an alert may be information regarding an IP address associated with a cause for the alert, a timestamp, a hostname, a short name, and a description of what type of change has occurred.

A reporting system is also associated with the user console 120. The reporting system organizes information stored in the database 140 to produce a report of information desired by the user. The user may obtain these reports in a variety of formats, for example, Microsoft Word, Adobe PDF or other printable formats. Reports produced by the reporting system may include, for example, a summary of vulnerabilities on a per host basis, details of vulnerabilities and changes detected within the network, reports of software installed on a per host basis and network configuration information. The user console 120 may also employ a graphical user interface.

The database 140 stores configuration information for the network in various formats, for example, Extensible Markup Language (XML). The database 140 also stores baseline network information for comparison with network information retrieved from a network scan by the scan engine 110. Database 140 may be a relational database, for example, Microsoft Access™, or a set of text files in, for example, an XML format. The relational portion of database 140 may include a number of tables which are used to store configuration information as well as information retrieved from the network, and results associated with the network subsequent to a scan of the network.

The database 140 stores XML settings that contain up to date configuration information for the system 100. The configuration information is created at start-up by the system 100 if such information does not already exist. The configuration information may contain user preferences and other system specific-settings desired by the user.

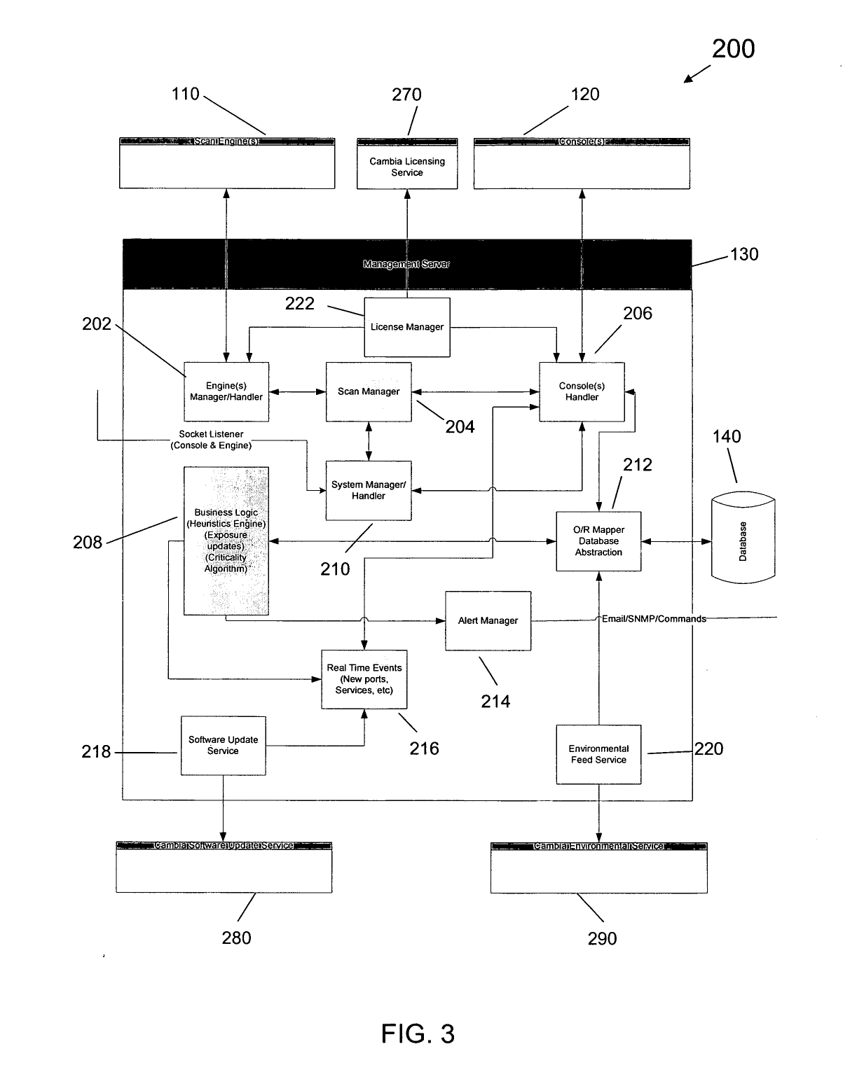

FIG. 3 illustrates components internal to the management server 130. The management server 130 includes an engine manager 202, a scan manager 204, a console handler 206, business logic 208, a system manager 210, an organizational/relational (O/R) mapper database abstraction 212, an alert manager 214, a real-time events manager 216, an environmental feed service 218, a software update service 220 and a license manager 222.

During operation, the management server 130 receives commands and information from the user console 120 and the scan engine 110. A system manager process/thread is central to the management server 130 and handles an establishment of initial communication from the scan engine 110 or the user console 120. If the system manager 210 detects a request for communications establishment from the scan engine 110, the system manager 210 spawns a scan manager process thread for the particular scan engine 110 that exists, which is used for the duration of the session. If the system manager 210 detects a request for communications establishment from the user console 120, the system manager 210 spawns a console handler process thread. Communications established for either request is conducted over an encrypted socket protocol over TCP/IP. The system manager 210 also accepts shutdown events and distributes them to the other processes within the network, so the network “shuts down” smoothly. The system manager 210 receives a socket listener signal from the user console 120 and the scan engine 110. The socket listener searches for new connections from the scan engine 110 or user console 120. If the socket listener detects a new connection request from the scan engine 110, the socket listener forwards the connection request to the scan manager 210. If the socket listener detects a new connection request from the user console 120, the socket listener forwards the connection request to the console manager 206.

The engine manager 202 handles communications between the scan engine(s) 110 and the management server 130. The engine manager 202 also authenticates the validity of a particular scan engine 110, and verifies with the license manager 222 that a customer is allowed to use the particular scan engine 110 requested. The license manager 222 also verifies whether the number of assets (devices on a user's network that are monitored by the system 100, for example, host computers, switches, routers and servers) is valid. The scan manager 204 establishes a scan manager process for every scan engine 110 communicating with the management server 130. The scan manager 204 is responsible for initiating scans and monitoring assets. Some requests for the use of the scan manager 204 may arrive via the user console 120. The console handler 206 receives a console handler process created by the system manager 210 for every scan engine 110 communicating with the management server 130. The console handler 206 also authenticates a user console 120, and verifies that a customer is allowed access to the management server 130 using the license manager 222.

Any information obtained during a scan is processed by business logic 208. Business logic 208 employs a variety of mechanisms, for example, heuristics engine logic, criticality calculation logic, environmental logic and various algorithms, to process the information received from scan engine 110 via engine manager 202. The heuristics engine logic performs the following tasks: (1) maintaining scan and network status information, (2) managing 3^{rd} party vulnerability scanners and data, (3) managing advanced scan modules (ASM)/Plug-in's and (4) performing baseline management and adherence for assets, asset groups and meta-assets. The criticality calculation logic performs criticality calculations on a per asset basis to determine a threat score and a criticality score for an associated service or device residing on the network. The environmental logic performs exposure matching and asset updating.

The O/R mapper database abstraction 212 is a database gateway that provides an object to a relational mapper for database 140 and provides a database abstraction layer. O/R mapper database abstraction 212 allows an application, for example, business logic 208, to access data from the database 140. The database abstraction layer provided by the O/R mapper database abstraction 212 may also validate all structured query language (SQL) required to access the database 140. In addition, O/R mapper database abstraction 212 verifies that a requester has appropriate permissions to access data.

The alert manager 214 establishes an alert manager process for providing external alerts via, for example, Email, SNMP or Command level access. The alert manager 214 receives events from the business logic 208 and applies alerting rules in order to format and generate appropriate external alerts. Real-time events manager 216 is similar to the alert manager 214, but acts as an event queue which is used by the user console 120. The event queue is a first in first out (FIFO) queue which stores messages and alerts. The event queue also dispatches these alerts to the user console 120, thereby allowing a user to view the latest alerts that have occurred prior to signing-on to the system 100.

The environmental feed service 218 polls the environmental server 280 periodically, for example, once every 15 minutes, to determine if the environmental feed service 218 detects the availability of new environmental data from environmental service 280. If new environmental data is available, the environmental feed service 218 will download the new data and post it to the database 140. Software update service 220 polls the update server 290 periodically, for example, once every 15 minutes, to determine if the software update service 220 detects the availability of a new software update from update server 290. If new updates are available, the software update service 220 will download the new update and notify system 100 administrators that an update is available. The software update service 220 also distributes updates to the appropriate areas of system 100, for example, the scan engine 110 and the user console 120.

The license manager 222 confirms that system 100 is validly licensed to a user based on a number of assets and advanced scan modules. The license manager 222 also tracks evaluation licenses and maintenance.

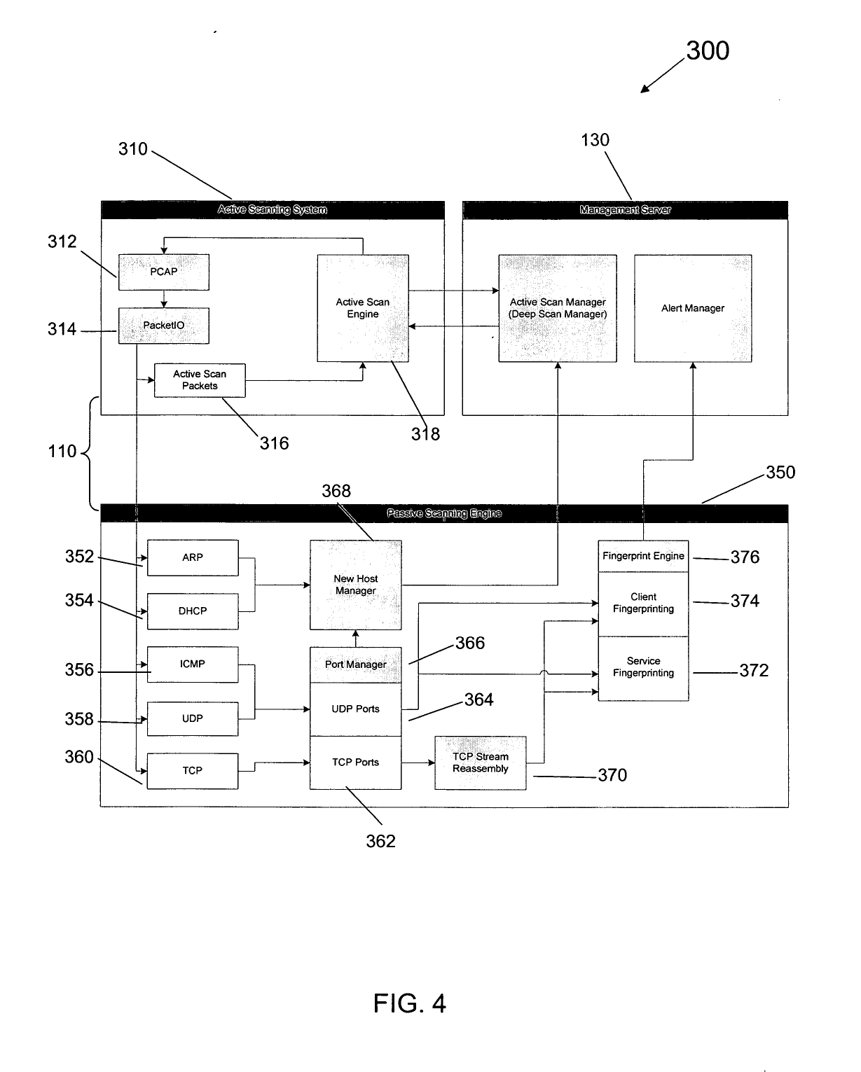

FIG. 4 illustrates components internal to the scan engine 110. Scan engine 110 includes an active scanning system 310 and a passive scanning engine 350. Active scanning engine includes packet capture (PCAP) 312, Packet IO 314, active scan packet 316 and active scan engine 318. Passive scanning engine 350 includes address resolution protocol (ARP) block 352, dynamic host configuration protocol (DHCP) block 354, internet control message protocol (ICMP) block 356, UDP block 358 and TCP block 360. Passive scanning engine 350 also includes TCP ports 362, UDP ports 364, a port manager 366, a new host manager 368, TCP stream reassembly 370, fingerprint engine 376, client fingerprinting 374 and service fingerprinting 372.

The scan engine 110 begins operation when it receives a command from the user console 120. Once the scan engine 110 receives a command, it obtains network baseline information from the database 140. The scan engine 110 also receives information concerning which IP addresses should be monitored and what type of monitoring should be employed.

A port profile associated with a network profile informs the scan engine 110 which TCP ports 362 and UDP ports 362 should be monitored. A vulnerability scan profile which is associated with a network profile informs the scan engine 110 of any external vulnerability scanners that should be launched if the scan engine 110 detects any changes to the network. The scan engine 110 may operate in a continuous loop on a per-network basis. In addition, multiple network profiles may be monitored simultaneously by scan engine 110.

When the scan engine 110 initially performs a scan of the network using a new network profile, the scan engine 110 obtains baseline information about systems and services on the network and stores the information in the database 140. Each subsequent scan by the scan engine 110 for the various systems and services on the network is compared to the initial baseline scan to detect whether or not the network has been altered. Any deviations from the baseline may cause an alert to be generated depending on settings within the alert manager 214 (FIG. 3). Subsequently, a vulnerability scanner script may be created to launch external scanners that may be required for a more in depth analysis of network deviations. If a deviation is determined to be benign, for example, the IT department installs a new service pack for existing software, scan engine 110 updates the network information stored in the database 140 with the current state of the network as the baseline.

The scan engine 110 uses a variety of algorithms to scan the network depending on the particular device, service or level on the network stack for the network the scan engine 110 is operating. If the scan engine 110 is operating at a lower layer of the network stack, the scan engine 110 may identify a host of an IP address using an ICMP block 356. In such a situation, passive scanning engine 350 will issue an ICMP echo request message via the ICMP block 356. As an alternative to using the ICMP block 356 to identify a host, passive scanning engine 350 could send a TCP packet having a synchronization (SYN) flag. If a TCP packet is received having a correct SYN and acknowledge (ACK) flag, the host is correctly identified.

Farther up the network stack, the scan engine 110 may connect to available services on multiple occasions to identify static information returned by the service. The scan engine 110 uses known information about the service for running static checks to obtain the characteristics of the service. Any static information received from the service is parsed by the scan engine 110 to create a change detection check. Each time the scan engine 110 scans the service, the static information is parsed to determine if the static information has changed. If a change is detected, an alert may be issued indicating that a change has been detected. For example, a banner check on a port (80) may be performed. The banner check would run periodically and would inform a connecting application about the service. The results of the banner check are subsequently used to detect changes within the service.

The scan engine 110 provides detection scanning capabilities for a web services layer. The scan engine 110 uses a web crawler which is a specialized differential check to identify links in a web page and follow the links in order to build an internal tree representation of a web server on the network. The scan engine 110 may monitor an individual web page or a set of web pages for deviations. In addition, web services may be monitored by scan engine 110. A simple object access protocol (SOAP) schema analyzer, which is a specialized differential check, may be employed for collecting baseline information about an existing SOAP and monitoring the SOAP for changes.

The scan engine 110 contains a plug-in/advanced scan module (ASM) architecture which allows an external dynamic link library to be loaded at scan run-time and tightly integrated with the scan engine 110. The management server 130 determines which plug-in/ASM will run on the scan engine 110. The management server 130 subsequently downloads the plug-in/ASM for use by the scan engine 110. Multiple plug-ins or ASMs may be used by the scan engine 110. Each plug-in/ASM connected to scan engine 110 is launched when a specific service or device is detected on the network, and the device or service is determined to be relevant to the particular plug-in/ASM; for example, launching a Microsoft Exchange plug-in when the scan engine 110 encounters a Microsoft Exchange server on the network. While a plug-in/ASM is operating, the plug-in/ASM temporarily takes control of scan engine 110. Thus, the plug-in/ASM may communicate with the device or service causing the plug-in/ASM to determine if a change has occurred. Since the plug-in/ASM has more in depth knowledge regarding a particular device or service, the level of deviation detection increases. If a deviation is detected, the plug-in/ASM will notify the scan engine 110 to issue an alert. Multiple plug-ins/ASM may be used for an individual device, service or network profile.

The scan engine 110 may include a built-in packet delivery scheduler which restricts the rate of data output according to bandwidth restrictions set by the user. These bandwidth shaping polices are stored in the database 140. In cases where the scan engine 110 must use an external library to communicate with the network, the scan engine 110 uses a built-in estimation of the bandwidth required to communicate with the external library. The bandwidth estimation is subsequently used to limit the rate at which the scan engine 110 communicates with the external library.

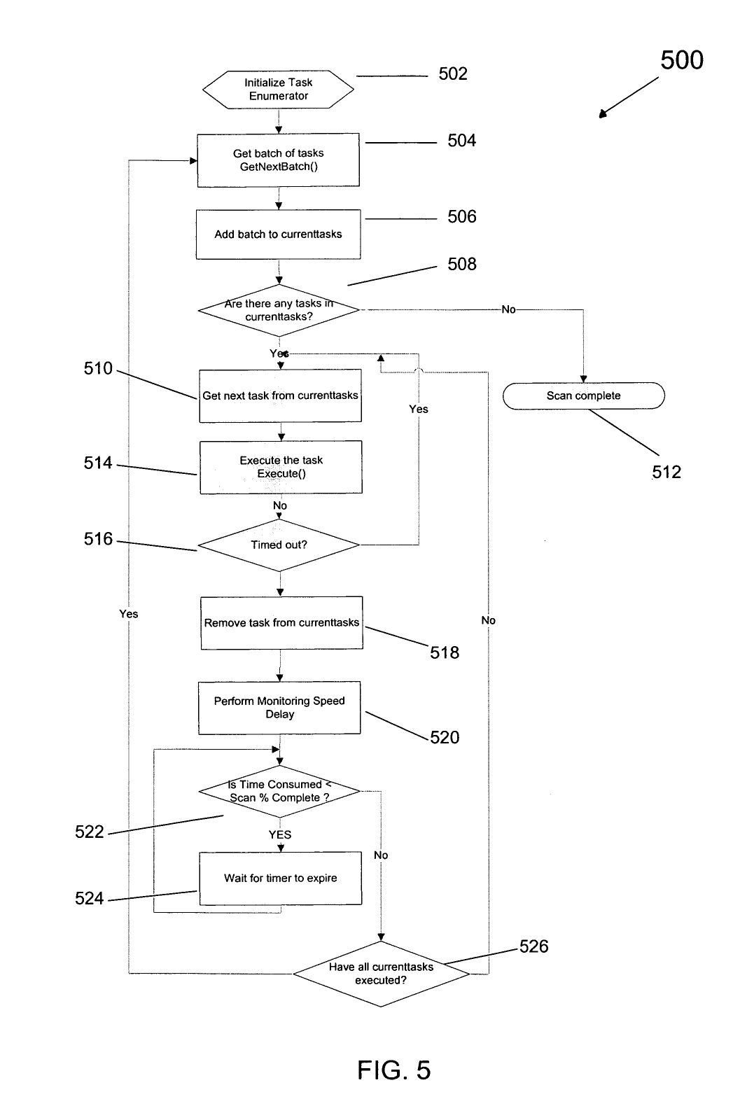

FIG. 5 is a flow chart 500 illustrating the continuous scanning loop implemented by the scan engine 110. At step 502, a TaskEnumerator object is initialized with scan data and an ArrayList is created to track the tasks currently running (currenttasks) in the scanning loop. At step 504, a batch of tasks is obtained from the TaskEnumerator using a batch loop. At step 506, the new batch of tasks that were acquired in step 504 are added to the batch of tasks running in currenttasks for execution by currenttasks. At step 508, the scanning loop determines if there are any tasks in currenttasks. If there is an additional task in currenttasks, the scanning loop proceeds to step 510 to obtain the task from currenttasks. If no tasks exist in currenttasks, at step 512, the scanning loop determines that the scan is complete.

At step 514, the scanning loop executes the task received from currenttasks. If a task returns a false value during its execution, the task has not finished. Because the task has not yet completed, a timeout value is returned at step 516. The timeout value is added to the total time requested by all tasks in currenttasks. Once completed, the task is removed from currenttasks at step 518.

At step 520, the scanning loop waits on a timer within the scan engine 110 which is set for an inter check. The delay in the scanning loop is, for example, 0 milliseconds (default) to a of maximum 20 milliseconds. At step 522, the scanning loop uses a timer within the scan engine 110 to smooth a scan performed by the scan engine 110 across the time allocated to the scan. For example, if a user sets the scan engine 110 to a single scan cycle running once every 20 minutes, and after 10 minutes more than 50% of the scan tasks have completed by the scan engine 110, the scan engine 110 will decrease the number of checks to utilize the entire 20 minutes. At step 524, a timer within the scan engine 110 is set based on the results from step 522. At step 526, once every task in currenttasks has been executed, the scan engine 110 will delay for an amount of time equal to the total time requested by the tasks before retuning to add another batch of tasks at step 504. If tasks exist that have not been completed, the scanning loop returns to step 510.

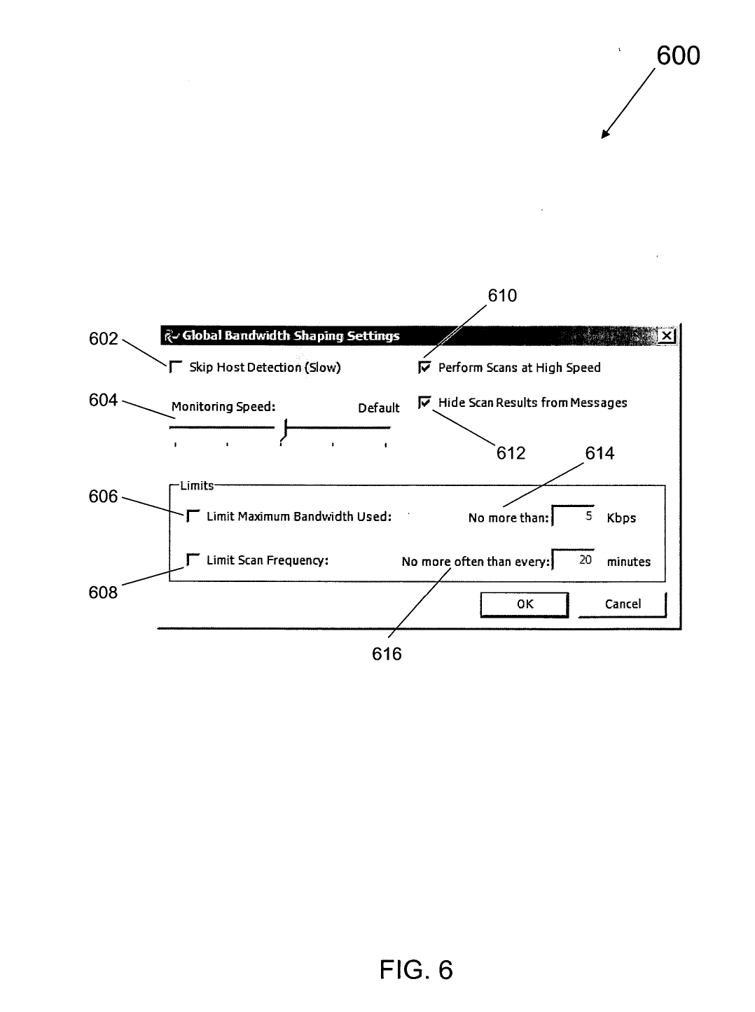

When utilizing the bandwidth shaping feature of system 100, the user, using a GUI residing on the user console 120 (FIG. 6), sets the desired bandwidth characteristics, for example, monitoring speed, maximum bandwidth and scan frequency, that will be used to constrain the scanning of the scan engine 110.

Using the bandwidth shaping GUI, the user may set an option for skip host detection 602. Setting the option for skip host detection 602 allows the scan engine 110 to perform port scans using active host detection. By performing port scans without using active host detection, a scan of the desired network devices and services is slow because all hosts in the network profile are scanned; including IP addresses which may not be in use. If enabled, skip host detection 602 causes the task enumerator (FIG. 5) to assume that all hosts in a range require port scanning. Normally only hosts found with ICMP echo requests are scanned. When skip host detection 602 is enabled, the task enumerator immediately begins port scanning hosts in the network profile address range. If a host responds to a connection attempt, either by refusing the connection or by accepting the connection, the scan engine 110 will send a “host found” message to the management server 130.

If skip host detection 602 is disabled, the task enumerator begins by pinging every host in a network profile address range. As soon as a host responds to the ICMP echo request, the task enumerator commences scanning the required ports on that host and sends a “host found” message to the management server 130.

The skip host detection 602 feature operates during an initialization portion of the task enumerator (FIG. 5, step 502). Accordingly, the skip host detection 602 occurs before the scanning starts.

The user may set an option for scanning at high speed (610). Using this setting allows the scan engine 110 to perform scans at very fast speeds because a monitoring speed option default 604 is overridden. By overriding the monitoring speed option default 604, output data packets are injected into a scan by the scan engine 110 are removed. Thus, the delay slows the scan engine's 110 ability to cycle through all the assets and all the ports on a user network.

The user may set as an option “hide scan results from message” (612). Using this setting limits the amount of messages displayed on the user console 120 during a scan to only those messages which indicate a change to the network or an alert.

The user may set an option for a monitoring speed (604). Using this setting causes the scan engine 110 to limit the rate of port and new host scans. Depending on the results scan engine 110 will cause delays in scanning to ensure that the average bandwidth used for the scan is not above the configured maximum. Delay times may, for example, be the following:
Very Slow—20 ms
Slow —10 ms
Default —5 ms
Fast —2 ms
Very Fast—0 ms

The user may set an option for an amount of bandwidth to be used during a scan (614). Using this setting, along with selecting a limit maximum bandwidth option 606, limits the maximum amount of bandwidth used by scan engine 110 during a scan by measuring the amount of traffic over the network. Each time the scan engine 110 sends network traffic, it notifies a bandwidth limiter (not shown). The bandwidth limiter may be implemented as a singleton object. The bandwidth limiter monitors network bandwidth regardless of the number of ongoing scans. The bandwidth limiter tracks the amount of used bandwidth through a bandwidth logger (not shown). The bandwidth logger also determines if a scan should be delayed based on bandwidth limitations.

The bandwidth logger stores bytes used in chains. One storage chain may be used to store a global limit. Another storage chain may be used to store each profile limit. Each link of a chain includes a time stamp and the number of bytes used. Each time the bandwidth logger logs bandwidth usage, it adds up the number of bytes sent over the network in a given period of time, for example, one second. Once a link is reached that contains information more than one second old, the chain is truncated.

In addition, the total number of bytes sent in the past second is divided by 1024 to determine the number of kilobytes transmitted. A per-profile or global limit is subsequently subtracted from the total. If final total is greater than zero, the bandwidth used by the scan engine 110 in the past second is too high and should be delayed. The delay time is calculated by dividing the final total by the profile limit, and multiplying by 1000. Thus, a rate of delay for bandwidth use may be the following:
Delay=((Bytes Sent)/1024−KB−Limit)/KB−Limit*1000

This calculation is performed for each profile and for a global profile. The amount of delay time is the maximum of the profile and global value. For example, if 4096 bytes have been sent in the past second and there is a 2 kilobit per second (Kbps) limit, the delay will be one second. After one second has elapsed, the average bandwidth used will be 2 Kbps over 2 seconds.

Other bandwidth limiters may entail using time-based configured bandwidth maximums. Using such a limiter would allow a finer-grained control, such as allowing different limits depending on the time of the day. For example, an administrator may desire limiting the bandwidth of network scans during work hours in order to avoid network lag for employees, but allow unlimited bandwidth to be used at night and on weekends when fewer people are in the office. Another bandwidth limiter used may be a traffic-based automatic bandwidth maximum. An algorithm could be used to determine the bandwidth to be used based on port scan timings. For example, if ICMP echo replies are returned more slowly than normal due network lag, the scan engine 110 could automatically adjust the amount of delay it inserts into a scan to diminish interference with network traffic.

The user may set an option to limit scan frequency 608. Using this setting limits the number of scans within a given time interval by allowing for a configured time period to elapse before performing another scan. The scan engine 110 will first calculate the percent of time used in light of the configured time allotted for a scan, or the percent of time allotted that has been consumed. The scan engine 110 will then calculate the percentage of the scan completed, which is calculated by dividing the number of ports that have been completely scanned by the total number of ports to scan. If the percent of time consumed is less than the percent of scan complete, a thread may wait 1 second and then perform the calculation again. The scan engine 110 will repeat this process until the scan complete percentage is equal to or greater than the time consumed percentage. The following algorithm may be used to ensure that the scan is evenly spaced over the time allotted:
TimeConsumed %=(CurrentTime−StartTime)/TimeLimit
ScanComplete %=PortsScannedSoFar/TotalPorts

In addition, by separating the new host scans from the port scans, an independent time cycle for new host scans may be set. By allowing fine-grained control over the amount of time spent scanning for new hosts or new ports vs. doing deep-dive (Differential Checks, ASM's, etc), an administrator is able to tailor the scanning of the network according to their own requirements and performance expectations.

Within business logic 208 (FIG. 2) resides a heuristics engine. The heuristics engine is used to identify pieces of data that uniquely identify an asset within the network and indicate when that asset has changed. The heuristics engine operates at three distinct layers of the network and each layer is a sub-component of the heuristics engine. These components are: (1) an IP layer, (2) application services and (3) web services. Each of these components run independently and is triggered by its lower-layer component. Thus, the IP layer feeds the application services layer which feeds the web services layer.

The IP layer of the heuristics engine is the first component that operates. Each time a new service is detected at a particular layer of the heuristics engine, the application services layer of the heuristics engine is launched. Once launched, the application services layer targets any service detected to gather more data about the service and how it could potentially change. If a particular service is identified as a web service, the web services layer of the heuristics engine is launched to provide web-specific data gathering for that component. The output of each of these components is transferred to the management server 130 for storage in the database 140.

The IP layer of the heuristics engine is configured with ranges of IP addresses known as network profiles. Each network profile is assigned a port range profile. The port range profile specifies the ranges of TCP and UDP ports to be monitored for activity. A criticality value may be assigned to the ports being monitored. After an initial baseline probe, the engine generates an alert to indicate a change has occurred to the previous or baseline state. If a change is detected, the application services layer of the heuristics engine may be launched to further interrogate the service.

The IP layer of the heuristics engine provides a continuous probe of IP addresses, TCP ports, and UDP ports. During probes, the IP layer searches the network for the appearance of new hosts and services. New hosts may be detected on the network either directly by probing the ICMP, or indirectly through identifying services on the device. Once a new service has been detected, the service is logged by the heuristics engine. The heuristics engine subsequently determines which checks to perform based on the service identification. If the service identification is a known service to the heuristics engine, the heuristics engine will have a set of defined checks for the service. The heuristics engine also detects the removal of a service from the network, and will issue an alert to the user via the user console 120 indicating which service has been removed. When probing the ICMP, an ICMP echo request message is sent across the network in an attempt to identify a host. If the host does not issue an ICMP echo reply verifying its existence, as in the case of a host with an intermediary firewall filtering such packets, the presence of one or more services running on the device indirectly indicates the existence of the host. The operation of TCP ports may be verified by delivering a TCP packet with the SYN flag set, and waiting for a reply of a TCP packet with the SYN and ACK flags set.

Application services of a network are identified and monitored for changes by the application services layer of the heuristics engine. The application services layer of the heuristics engine attempts to interrogate a particular service for static data points. During an interrogation, if the service returns different information than the information received from a previous interrogation, a change in the service has most likely occurred and further investigation may be needed.

The application services layer of the heuristics engine operates using regular expression checks to parse the output of a TCP or UDP level service. Checks may either be generated by the user, or automatically generated by the heuristics engine. In the case of user generated checks, the user has several options for creating the check. Checks which are available to the user may be the following: (1) banner, (2) challenge/response, and (3) secure shell (SSH). A banner check connects to a service and reviews the output of the service without sending any data to the service. A challenge/response check connects to a service and sends data to the service, and subsequently inspects the output returned from the service. An SSH check connects to a service, authenticates itself to the service through the SSH, sends data to the service, and inspects the output returned from the service.

Each type of check may parse the output of the service in one of the following manners: simple, parsed, or time-stamped. Using a simple parse stores the output from the service and identifies any change to the entire output of the service. Using a parsed option passes the output from the check through a regular expression parser. The regular expression parser may modify the output of a check. If the output from the regular expression changes, a change is deemed to have occurred. When using a time-stamped parse, any recognizable date or time string in the output of the system is eliminated, and if any other data in the output from the service has changed, a change is deemed to have occurred. Thus, the likelihood of issuing a false alert is decreased because the check ignores the constantly changing date and time.

Although users may create their own checks, the heuristics engine has the ability to generate the same checks automatically. Automatic check generation may occur when a new service is initially detected on an asset. The heuristics engine may connect to a service several times in succession to determine if particular aspects of the data returned by the service may be associated with one of the check types supported by the heuristics engine.

For example, if a simple mail transfer protocol (SMTP) service is discovered on an asset, over the course of several seconds the heuristics engine will connect to the SMTP service. Subsequently, the heuristics engine may receive a return string containing three key data points: (1) a name for a server, (2) a version of software the server is running and (3) the current time on the server. The heuristics engine will identify the time as a changing data point each time it connects to the service, while the server name and software version are static components. A timestamp check will then be created in the asset for that service on the asset, and each time the IP layer of the heuristics engine discovers the service operating, the application service layer of the heuristics engine is launched. The application service layer will inspect the service to determine if the service is returning the same server name and software version, while ignoring the timestamp.

The web services layer of the heuristics engine allows a user to detect changes in web services and files hosted on a web server. A web service may be any service that is accessed by a GET or POST on a Web server, including a standard file, a common gateway interface (CGI) script, or a SOAP service. Services may be monitored by writing specific checks which look for a particular service, or through a web crawler which searches through links of web pages to build a directory of files.

Checks may be written having a pathname or filename for a web service and are used to identify the web service on a web server. The check identifies the service using either a hypertext transfer protocol (HTTP) GET or POST, along with a set of parameters passed to the service. A check may be mapped to a particular directory on a web server, or each directory found on the web server may be queried for the existence of the service. A check may identify a change that has occurred either upon the existence of the web service, a change in output to a request for the web service, or a change in output to a request for the web service initially passed through a user-specified regular expression. Web services utilizing a SOAP protocol will also have the SOAP schema queried and parsed to determine if the SOAP schema has changed.

Individual files residing on a web server may also be monitored for a change. A GUI representation of a web server directory tree is displayed for the user in the user console 120. The user may then specify individual files that should be monitored on the web server, and may designate criticality levels associated with a change in the file. The web services layer of the heuristics engine will determine if the file returns a static result. If a static result is returned, the file is suitable for change monitoring. However, if the file is a dynamic page, it may not provide useful output for change monitoring.

If the scan engine 110 detects any changes to the network, the scan engine 110 may launch a variety of external scanners, for example ISS Internet Scanner. In order to coordinate the launch of external scanners by the scan engine 110, the system 100 employs a scripting language. The scripting language has two main components, comments and commands.

Comments are enclosed in square braces ([ ]), and can span multiple lines. Any information within the square brackets is removed from the input stream when the script is executed. Commands are terminated by the end of a line (\r\n). Blank lines or lines consisting only of white-space are ignored. A command may have the following form:
<conditional portion>: <scanner to execute>

Thus, a command is a conditional expression, followed by the colon character, followed by a scanner that is desired to be launched. The top-level of a conditional expression is a function call, which may use multiple arguments that are separated by white-space and may take the following form:
functionname(arg arg . . . )

Arguments in the function may be integers (a string of digits), strings (“double-quoted string values” with double-quotes and backslashes escaped using \), or an embedded function call, which may assume various arguments. A return value of the top-level function is evaluated as a boolean expression. The evaluation determines whether or not the particular scanner following the colon in the command should be launched. When evaluating values for functions that accept booleans as parameters, a false value results from either an integer being 0 or an empty string; all other values are assigned a true value.

The scanner portion of the command may have the following form:
<scanner id>[“optional argument”]

Scanner id may be an integer indicating which scanner to launch. The optional argument may be a string value (enclosed in quotes), which is scanner-specific. Typically, the optional argument is the name of a pre-configured profile used to read the scanner settings.

When the scan engine 110 executes a scan, the heuristics engine determines which scanner profile, if any, is associated with the network profile being scanned. The script for the particular profile is then evaluated for each open host in the scan to obtain a list of scanners that may run on the host. Each time the script is evaluated, an interpreter reads each logical command from top to bottom. Each conditional portion that evaluates as true results in the corresponding scanner being added to the list.

An ID script may also be employed by the system 100 to coordinate the ID's of the various scanners, web checks and application checks which reside in the network. Because users may not want to look up the values of each ID in the database 140, an “Insert Statement” dialog box is available in the user console 120 GUI.

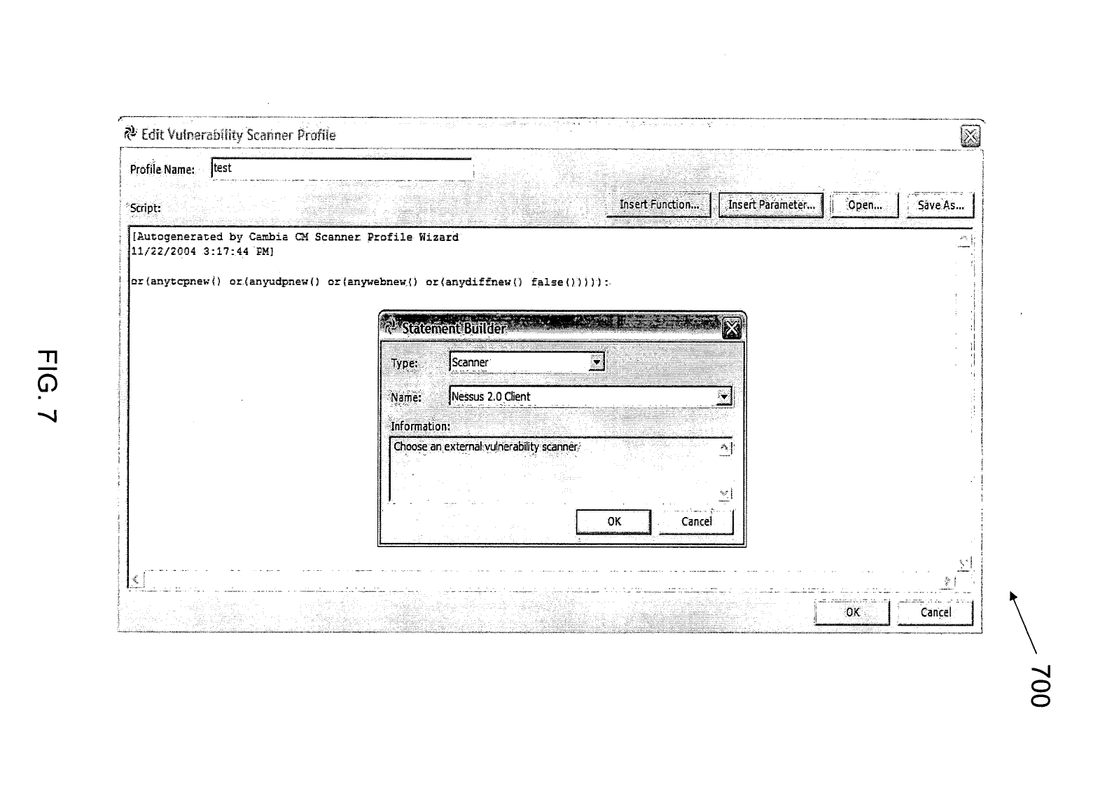

FIG. 7 illustrates the “Insert Statement” dialog box 700 that may be used by a user when coordinating the ID's of the various scanners, web checks and application checks which reside in the network. The dialog box presents three boxes. The first box allows the user to select a type of value, for example, “Scanner”, “Scanner Param”, “Application Check”, or “Web Check.” When scanner, Application Check or Web Check is selected, the user may select a value in a second box for inserting the correct ID for the scanner or diff into the script text, along with a comment indicating the name with which the ID corresponds. When the “Scanner Param” is selected, the user may select a scanner from the second box which will cause the third box to be populated with a list of available parameters for a particular scanner.

The script for the scan engine 110 may run a 3^{rd} party scanner such as an Internet Security Systems Scanner Rules (ISS) Scanner (Nessus) any time a new web check appears, and may also run Nessus if any other changes are detected. Finally, it may utilize an imaginary scanner “hostchecker” if no other scanner has been launched. The hostchecker is a virtual script created via the user console 120 for use by the scan engine 110 on a specific asset/host after specific circumstances have been detected. An exemplary script may be the following:

anywebnew( ): 13[ISS Scanner 7.0] “My ISS Web Profile”
or(anytcpnew( ) anyudpnew( ) anydiffhew( )): 14[Nessus
Client 2.0] “Nessus

Profile”

and(not(scanhasrun(13[ISS Scanner 7.0]))
not(scanhasrun(14[Nessus Client

2.0]))): 200[hostchecker]

Functions that may be used in the scan engine script may include the following:

| FUNCTION | DESCRIPTION |
|---|---|
| and(bool bool) ==> bool | Returns the logical “and” |
| | of its arguments. |
| or(bool bool) ==> bool | Returns the local “or” |
| | of its arguments. |
| not(bool) ==> bool | Returns the logical |
| | opposite of its argument. |
| true( ) ==> bool | Returns a true boolean |
| | value. |
| false( ) ==> bool | Returns a false boolean |
| | value. |
| equals(any any) ==> bool | Compares the two values to |
| | determine if they are equal. |
| | These can either be two |
| | strings, two integers, or |
| | a boolean value and any |
| | other type. |
| hoststatus( ) ==> string | Returns a value indicating |
| | the state of the host |
| | of the script is being |
| | evaluated. May be either |
| | “open” or “new.” |
| tcpstatus(int) ==> string | Returns the status of a |
| | TCP port given as the |
| | first argument on the |
| | host. May be either |
| | “open”, “new”, or |
| | “closed.” |
| anytcpopen( ) ==> bool | Returns true if any |
| | TCP ports are open on |
| | the host, otherwise |
| | false. |
| anytcpnew( ) ==> bool | Returns true if any |
| | TCP ports are open AND |
| | appeared for the first |
| | time in this scan, |
| | otherwise false. |
| udpstatus(int) ==> string | Returns the status of |
| | a udp port given as the |
| | first argument on the |
| | host. Can be either |
| | “open”, “new”, or |
| | “closed.” |
| anyudpopen( ) ==> bool | Returns true if any |
| | UDP ports are open on the |
| | host, otherwise false |
| anyudpnew( ) ==> bool | Returns true if any |
| | UDP ports are open AND |
| | appeared for the first |
| | time in this scan, |
| | otherwise false. |
| diffstatus(int) ==> string | Returns the status of |
| | an application diff |
| | vulnerability given as |
| | the first argument on the |
| | host. |
| | Can be either “open”, |
| | “new”, or “closed.” |
| anydiffopen( ) ==> bool | Returns true if any |
| | application diff |
| | vulnerabilities are open |
| | on the host, otherwise |
| | false. |
| anydiffnew( ) ==> bool | Returns true if any |
| | application diff |
| | vulnerabilities are |
| | open AND appeared for the |
| | first time in this |
| | scan, otherwise false. |
| webstatus(int) ==> string | Returns the status of |
| | a web diff vulnerability |
| | given as the first |
| | argument on the host. |
| | Can be either “open”, |
| | “new”, or “closed.” |
| anywebopen( ) ==> bool | Returns true if any |
| | web diff vulnerabilities |
| | are open on the host, |
| | otherwise false. |
| anywebnew( ) ==> bool | Returns true if any web |
| | diff vulnerabilities are |
| | open AND appeared for |
| | the first time in this |
| | scan, otherwise false. |
| scanhasrun(int) ==> bool | Returns true if the |
| | scanner of the given ID |
| | has been set to execute |
| | by the evaluation of a |
| | previous command on |
| | this host. |

Another exemplary script implementation may be a script that launches an ISS scanner whenever a new TCP port opens, but launches a Microsoft Baseline Security Analyzer (MBSA) if a new application differential has been launched and an ISS scanner has not previously been launched. The following may be included in the script:

anytcpnew( ): 13[ISS Internet Scanner 7.0] “my policy”
and(anydiffnew( ) not(scanhasrun(13[ISS Internet Scanner
7.0]))): 16[Microsoft
Baseline Security Analyzer 1.1.1 - 1.2]

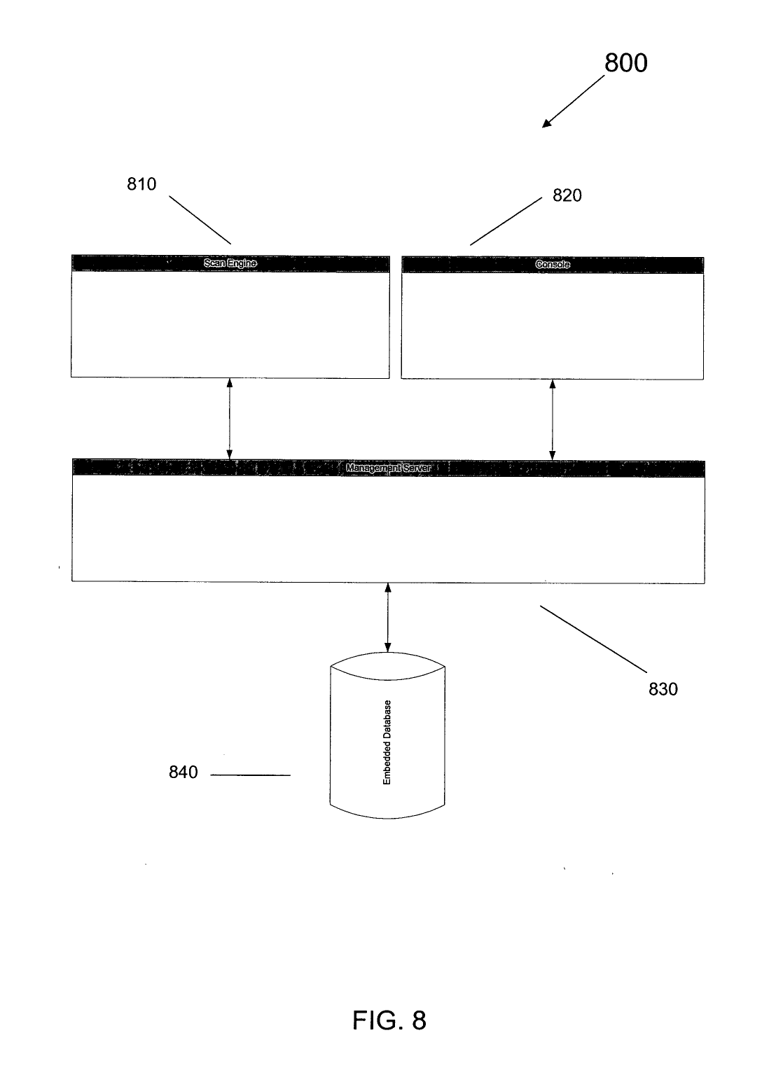

FIG. 8 is a second exemplary embodiment of the present invention. The system 100 may be implemented as a stand-alone build, system 800. In this embodiment, the database 140 is not employed since the system 800 accesses an embedded database 840. In addition, the system 800 utilizes a single scan engine 810 and a single user console 820. When a user interacts with the user console 820, the system 800 starts the management server 830 and the scan engine 810. In this embodiment, the user does not have the option of configuring the scan engine 810 or the management server 830. The system 800 does not utilize a network socket and uses interprocess communication (IPC) as a communications medium within the system and network. The system 800 passes message objects between threads directly instead of serializing the message objects and passing the message over the network. Accordingly, the system 800 operates in an asynchronous manner.

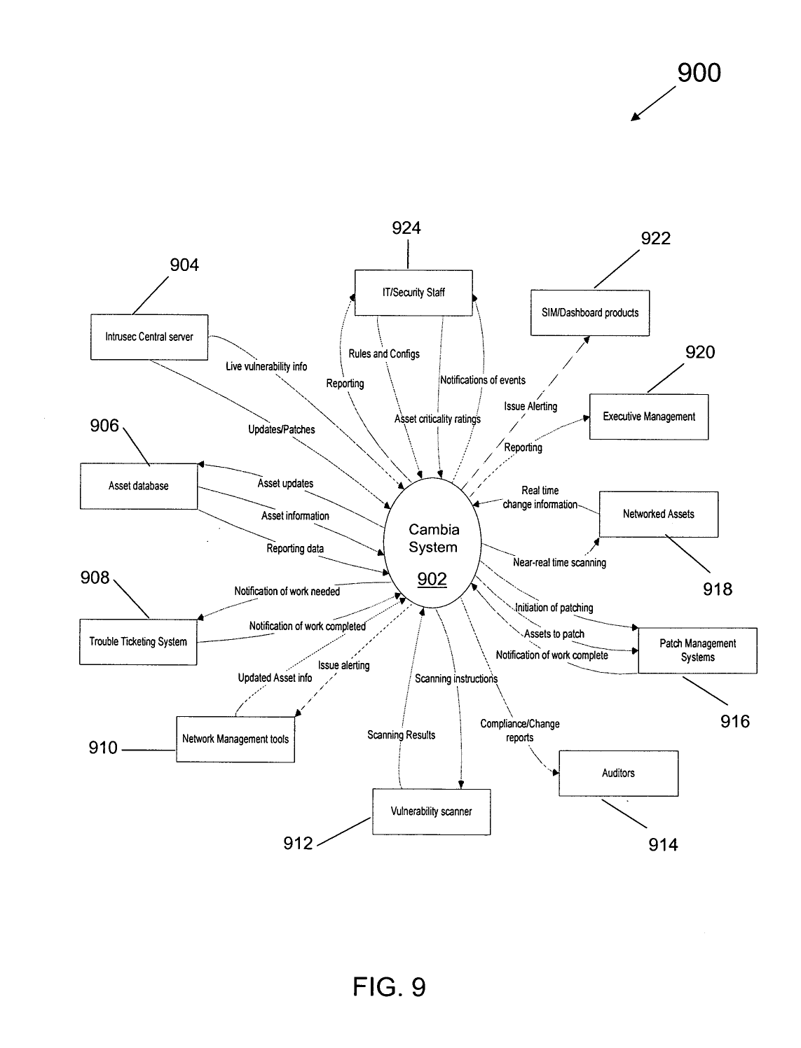

FIG. 9 illustrates a computer system 900 which includes the system 100 or system 200 (system 902) interacting with a network having various scanners and intrusion detection systems. As illustrated, the system 902 interacts with an IT staff 924 by receiving information regarding rules, configuration information and asset criticality ratings used by the system 902 during scanning. The system 902 also sends notifications of events triggered due to changes to the network and sends reports to the IT staff network regarding configurations and changes.

The system 902 interacts with a system update server 904 to receive updates and patches for the system 902 and also receives live vulnerability information from the system update server 904.

The system 902 interacts with a vulnerability scanner 912 which is connected to the network. During operation, the system 902 and the vulnerability scanner 912 exchange network scanning instructions and subsequent scan results.

The system 902 also interacts with an asset database 906, a trouble ticket system 908, network management tools 910, an auditing system 914, patch management systems 916, network assets 918, an executive management system 920 and Security Information Management (SIM)/Dashboard products 922. Thus, the system 902 has the ability to provide reports about the network to various segments and receive various instructions and notifications from various segments within the system 900.

While the invention has been described in detail in connection with exemplary embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. In particular, the specific embodiments of the real-time change detection system described should be taken as exemplary and not limiting. Accordingly, the invention is not limited by the foregoing description or drawings, but is only limited by the scope of the appended claims.

1. A method of assessing network change comprising:
receiving data traffic from a network;
establishing a baseline configuration for the network;
scanning the data traffic for the network in a continuous manner; and
comparing the scanned data traffic with the baseline configuration to determine if a change to the network has occurred.

2. The method of claim 1, wherein the comparison occurs in real-time.

3. The method of claim 1 further comprising issuing an alert to a network administrator if a change to the network has been detected.

4. The method of claim 3, wherein the alert to the network administrator occurs in real-time.

5. The method of claim 1 further comprising launching at least one vulnerability scanner to be used by the network if a change to the network is detected.

6. The method of claim 1, wherein the comparison step uses a detection algorithm.

7. The method of claim 1, wherein the scanning step uses a continuous scanning algorithm.

8. The method of claim 1 further comprising using a module having deep knowledge about a particular part of the network to identify changes to the particular part of the network.

9. The method of claim 1 further comprising limiting a bandwidth used during the scanning step.

10. The method of claim 1 further comprising reporting network information to a network administrator.

11. The method of claim 1 further comprising storing an inventory of devices and services connected to the network.

12. The method of claim 11, wherein the inventory is updated in real-time.

13. The method of claim 1 further comprising receiving operation preferences from a network administrator using a graphical user interface.

14. A computer based medium, comprising an application being executable by a computer, wherein the computer executes the steps of:
receiving data traffic from a network;
establishing a baseline configuration for the network;
scanning the data traffic for the network in a continuous manner; and
comparing the scanned data traffic with the baseline configuration to determine if a change to the network has occurred.

15. The computer based medium of claim 14, wherein the comparison occurs in real-time.

16. The computer based medium of claim 14, further comprising issuing an alert to a network administrator if a change to the network has occurred.

17. The computer based medium of claim 16, wherein the alert to the network administrator occurs in real-time.

18. The computer based medium of claim 14, further comprising launching at least one vulnerability scanner to be used by the network if a change to the network is detected.

19. The computer based medium of claim 14, wherein the comparison step uses a detection algorithm.

20. The computer based medium of claim 14, wherein the scanning step uses a continuous scanning algorithm.

21. The computer based medium of claim 14 further comprising using a module having deep knowledge about a particular part of the network to identify changes to the particular part of the network.

22. The computer based medium of claim 14, further comprising limiting a bandwidth used during the scanning step.

23. The computer based medium of claim 14, further comprising reporting network information to a network administrator.

24. The computer based medium of claim 14 further comprising storing an inventory of devices and services connected to the network.

25. The computer based medium of claim 24, wherein the inventory is updated in real-time.

26. The computer based medium of claim 14, further comprising receiving operation preferences from a network administrator using a graphical user interface.

27. A system for assessing network change comprising:
a computer system including a processor for executing computer code; and
an application for execution on the computer system, wherein the computer system, when executing the application receives data traffic from a network, establishes a baseline configuration for the network, scans the data traffic for the network in a continuous manner, and compares the scanned data traffic with the baseline configuration to determine if a change to the network has occurred.

28. The system of claim 27, further comprising a management server for coordinating communications between at least one scan engine and at least one user interface, wherein the communications are used in determining if the network has changed.

29. The system of claim 28, wherein the management server coordinates information transferred from a database containing network information and sends network information to the database based on requests by the user interface and the scan engine.

30. The system of claim 29, wherein the database stores information associated with an inventory of devices and services connected to the network.

31. The system of claim 30, wherein the inventory is updated in real-time.

32. The system of claim 28, wherein the communications between the management server, the at least one scan engine and the at least one use interface uses an encrypted socket protocol.

33. The system of claim 28, wherein the management server maintains relational information between at least one client and the network.

34. The system of claim 28, wherein the scan engine scans data traffic in a continuous manner.

35. The system of claim 34, wherein the scan engine scans data in real-time.

36. The system of claim 28, wherein the scan engine uses a module to obtain information particular to a network device for use in scanning the particular network device.

37. The system of claim 28 wherein the scan engine uses a web crawler to identify links in a web page for use when scanning a web service.

38. The system of claim 28, wherein the scan engine separates a host scan from a port scan for use by a network administrator in controlling scan engine performance.

39. The system of claim 28 wherein the scan engine further comprises a heuristics engine for identifying a particular asset on the network and indicating when the particular asset on the network changes.

40. The system of claim 28 wherein the scan engine a bandwidth shaping algorithm for limiting a bandwidth used by the system when communicating with network devices.

41. The system of claim 28, wherein the scan engine launches at least one vulnerability scanner to be used by the network if a change to the network is detected.

42. The system of claim 28, wherein the scan engine uses a scripting language to launch external scanners and external intrusion detection systems.

43. The system of claim 28, wherein the scan engine uses a detection algorithm to determine if a change to the network has occurred.

44. The system of claim 28, wherein the scan engine uses a continuous scanning algorithm.

45. The system of claim 28, wherein the user interface is a graphical user interface.

46. The system of claim 28, wherein the user interface is used to modify a network profile.

47. The system of claim 28, wherein a network administrator uses the user interface to assign a criticality level to a device connected to the network.

48. The system of claim 27 further comprising an alert manager for issuing an alert to a network administrator if a change to the network has occurred.

49. The system of claim 48, wherein the alert from the alert manager to the network administrator occurs in real-time.

50. The system of claim 27, wherein the system reports network information to a network administrator.

51. A system for assessing network change comprising:
means for receiving data traffic from a network;
means for establishing a baseline configuration for the network;
means for scanning the data traffic for the network in a continuous manner; and
means for comparing the scanned data traffic with the baseline configuration to determine if a change to the network has occurred.

52. A heuristics engine comprising:
an IP layer component for monitoring at least one port of a network;
an application services component for monitoring at least one application running on the network; and
a web services component for monitoring at least one web service running on the network.

53. The engine of claim 52, wherein the IP layer component monitors a TCP port.

54. The engine of claim 52, wherein the IP layer component monitors a UDP port.

55. The engine of claim 52, wherein the IP layer component monitors a port range.

56. The engine of claim 52, wherein the IP layer component issues an alert to a network administrator if a change occurs to a port between scans.

57. The engine of claim 52, wherein the IP layer component continuously scans at least one IP addresses, at least one TCP port and at least one UDP port.

58. The engine of claim 52, wherein the IP layer component continuously scans at least one IP addresses, at least one TCP port or at least one UDP port.

59. The engine of claim 52, wherein the IP layer component launches the application services component to obtain information about a service.

60. The engine of claim 52, wherein the application services component interrogates a service to obtain statistical data point from the service.

61. The engine of claim 52, wherein the application services component parses check information from a service.

62. The engine of claim 52, wherein the web services component determines if a change to a web service has occurred.

63. The engine of claim 52, wherein the web services component determines if a change to a file hosted on a web server has occurred.

64. The engine of claim 52, wherein the web services component uses a check to identify whether a change has occurred within a web service.

65. The engine of claim 52, wherein the web services component creates a graphical representation of a web server directory tree for use in monitoring a web server.

66. A computer based medium, comprising: an application being executable by a computer, wherein the computer executes the steps of:
receiving network traffic from a network;
setting a baseline network configuration based on the network traffic received; and
scanning the network in a continuous manner to determine if a change has occurred to the network, wherein the scanning of the network is limited by a bandwidth setting which establishes a maximum usable bandwidth for a scan engine during the scan.

67. The computer based medium of claim 66, wherein a network administrator sets the bandwidth settings.

68. The computer based medium of claim 66, wherein a network administrator sets a skip host detection setting for performing port scans using active host detection.

69. The computer based medium of claim 66, wherein a network administrator sets a port and new host scanning rate.

70. The computer based medium of claim 66, wherein a bandwidth logger is used to track the bandwidth being used during a scan.

71. The computer based medium of claim 70, wherein the bandwidth logger delays a scan if the maximum usable bandwidth has been reached for the scan engine.

72. The computer based medium of claim 71, wherein the amount of delay for the scan is calculated using a rate of delay algorithm.

73. The computer based medium of claim 66, wherein the maximum usable bandwidth for a scan is set by a network administrator according a network usage schedule.

74. The computer based medium of claim 66, wherein a network administrator sets a maximum number of scans of the network that may occur within a predetermined period of time.
